(19) United States
(12) Patent Application Publication
(10) Pub. No.: US 2015/0292710 A1
(43) Pub. Date: Oct. 15, 2015

(54) LAMP STRUCTURE

(71) Applicant: Genesis Photonics Inc., Tainan City (TW)

(72) Inventor: Cheng-Yen Chen, New Taipei City (TW)

(21) Appl. No.: 14/684,416

(22) Filed: Apr. 12, 2015

(30) Foreign Application Priority Data
Apr. 11, 2014 (TW) 103113353

(51) Int. Cl. F21V 7/00; F21K 99/00; F21V 17/10; F21V 3/04; F21V 29/70

(52) U.S. Cl. CPC F21V 7/0066; F21V 3/0472; F21V 29/70; F21V 17/101; F21K 9/50

(57) ABSTRACT

A lamp structure is disclosed. The lamp structure includes: a lamp cover having a bottom side and light-emitting side opposing to the bottom side, a reflection layer being disposed on the bottom layer; a substrate disposed on the bottom side of the lamp cover; at least one light-emitting unit disposed on the substrate to emit a plurality of light beams; and a reflection member disposed above the light-emitting unit. The light beams are at least reflected by the reflection layer of the lamp cover, and are emitted from the light-emitting side of the lamp cover.

### CROSS-REFERENCE TO RELATED APPLICATION

This application claims the priority benefit of Taiwan application serial no. 103113353, filed on Apr. 11, 2014. The entirety of the above-mentioned patent application is hereby incorporated by reference herein and made a part of this specification.

### BACKGROUND OF THE INVENTION

1. Field of the Invention

The invention relates to a lamp structure, and particularly relates to a lamp structure having a reflection member.

2. Description of Related Art

Light-emitting diodes (LED) have the advantages of small volume, low power consumption, shock resistance, quick reaction speed, long lifetime, and no mercury and thus environmental friendly. Due to the awareness of environmental protection and power saving, LEDs have been broadly used in a variety of luminaires.

However, when LEDs emit light, a significant amount of heat is generated accordingly. The accumulation of heat may result in significant light decay of LED in a high temperature environment. The brightness and lifetime of LED are thus influenced.

Moreover, the consumers' demands to luminaires are higher and higher. If light is directly emitted from the luminaires, there may be glare that influence the health of human eyes.

### SUMMARY OF THE INVENTION

Based on the above, the invention provides a lamp structure that reduces glare of luminaires.

Also, the invention provides a lamp structure with a preferable heat dissipating efficiency and reliability.

The invention provides a lamp structure, including: a lamp cover, wherein the lamp cover has a bottom side and a light-emitting side opposing to the bottom side, and a reflection layer is disposed at the bottom side; a substrate, disposed on the bottom side of the lamp cover; at least one light-emitting unit, disposed on the substrate and emitting a plurality of light beams; and a reflection member, disposed above the light-emitting unit, wherein the light beams are at least reflected by the reflection layer of the lamp cover and emitted from the light-emitting side of the lamp cover.

According to an embodiment of the invention, the at least one light-emitting unit are located between the reflection member and the substrate.

According to an embodiment of the invention, a material of the reflection member is selected from a group consisting of aluminum, tin, copper, silver, and gold.

According to an embodiment of the invention, the reflection member includes a heat dissipating member disposed at a side of the reflection member facing the light-emitting side of the lamp cover.

According to an embodiment of the invention, a minimal distance between the reflection member and the bottom side of the lamp cover is in a range of 1/2 to 1/3 times of a maximal distance between the light-emitting side and the bottom side.

According to an embodiment of the invention, the lamp structure further includes a packaging unit covering the light-emitting unit. In addition, the reflection member is disposed on the packaging unit.

According to an embodiment of the invention, the reflection member comprises a first reflection portion and a second reflection portion, the first reflection portion is located between the second reflection portion and the substrate.

According to an embodiment of the invention, the first reflection portion and the second reflection portion are integrally formed.

According to an embodiment of the invention, a width of the second reflection portion is greater than a width of the first reflection portion.

According to an embodiment of the invention, a side of the second reflection portion facing the substrate has a recessed portion or a protruding portion.

According to an embodiment of the invention, the first reflection portion is located on the recessed portion or the protruding portion of the second reflection portion.

According to an embodiment of the invention, the number of the light-emitting unit is plural and the light-emitting units are arranged on the substrate.

According to an embodiment of the invention, the light-emitting units surround the first reflection portion.

According to an embodiment of the invention, the lamp structure further includes a packaging unit covering the light-emitting unit, wherein the reflection member is surrounded by the packaging units.

According to an embodiment of the invention, the first reflection portion is fixed on the substrate through screwing, engaging, locking, or adhering.

According to an embodiment of the invention, a width of the second reflection portion is greater than a width of the first reflection portion.

According to an embodiment of the invention, a side of the second reflection portion facing the substrate has a recessed portion or a protruding portion.

According to an embodiment of the invention, the first reflection portion is located on the recessed portion or the protruding portion of the second reflection portion.

According to an embodiment of the invention, the numbers of the first reflection portion and the light-emitting unit are plural, and each of the light-emitting units is disposed between the corresponding first reflection portions.

According to an embodiment of the invention, at least portion of the first reflection portion is surrounded by the light-emitting units.

According to an embodiment of the invention, the lamp structure further includes a packaging unit covering the light-emitting units, wherein the at least portion of the reflection member is surrounded by the packaging unit.

Based on the above, the lamp structure of the invention may have one or more of the following characteristics:

In the lamp structure of the invention, the reflection member is disposed in the lamp structure. In this way, the light beams emitted by the light-emitting unit are not directly emitted forwardly from the light-emitting unit, but are emitted from the lamp cover through reflection. Thus, glare in conventional lamps may be reduced.

Also, in the lamp structure of the invention, with the reflection member having a heat dissipating function, a heat dissipating efficiency and reliability of the lamp structure may be increased.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view illustrating a lamp structure according to a first embodiment of the invention.

FIG. 2 is a top view of the lamp structure according to the first embodiment of the invention shown in FIG. 1.

FIG. 3 is a schematic cross-sectional view illustrating a lamp structure according to a second embodiment of the invention.

FIG. 4 is a schematic cross-sectional view illustrating a lamp structure according to a third embodiment of the invention.

FIG. 5 is a schematic cross-sectional view illustrating a lamp structure according to a fourth embodiment of the invention.

FIG. 6a is a schematic view illustrating a first configuration of a reflection member in a lamp structure of the invention.

FIG. 6b is a schematic view illustrating a second configuration of a reflection member in a lamp structure of the invention.

FIG. 7 is a schematic cross-sectional view illustrating a lamp structure according to a fifth embodiment of the invention.

FIG. 8 is a top view of the lamp structure according to the fifth embodiment of the invention shown in FIG. 7.

FIG. 9 is a schematic cross-sectional view illustrating a lamp structure according to a sixth embodiment of the invention.

FIG. 10 is a top view of the lamp structure according to the sixth embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

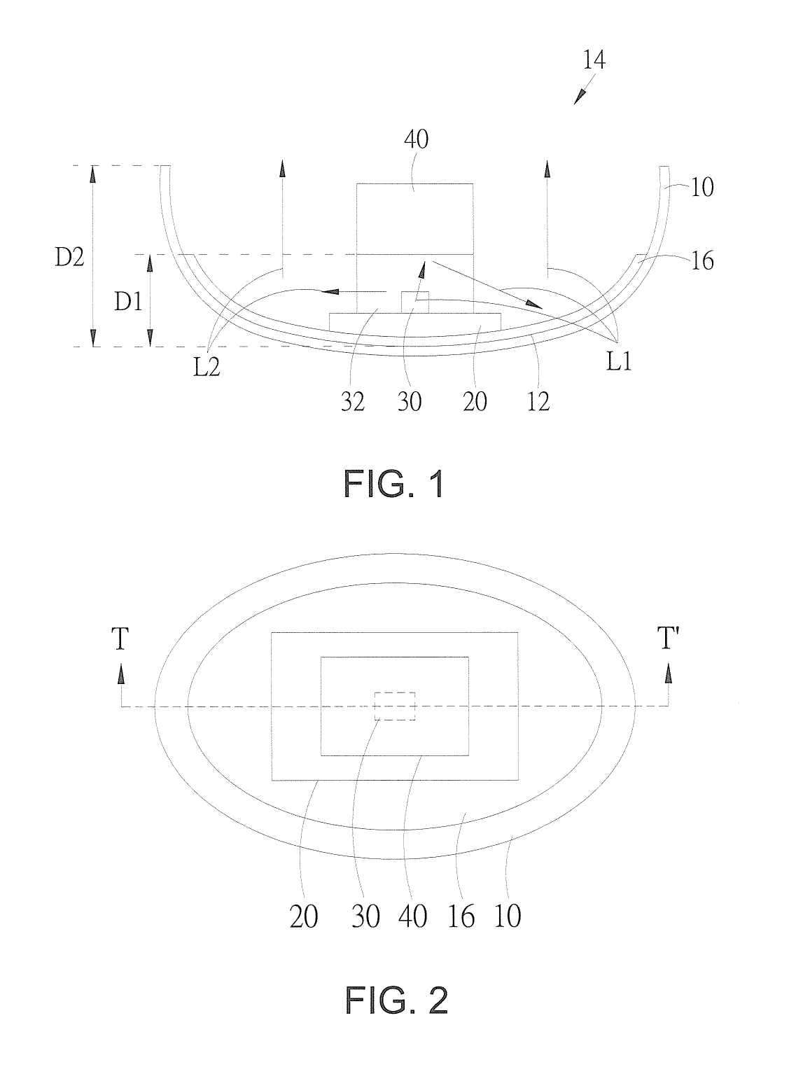

Referring to FIGS. 1 and 2, FIG. 1 is a schematic cross-sectional view illustrating a lamp structure according to a first embodiment of the invention, and FIG. 2 is a top view of the lamp structure according to the first embodiment of the invention shown in FIG. 1. As shown in FIGS. 1 and 2, the lamp structure of the invention includes: a lamp cover 10, a substrate 20, at least one light emitting unit 30, and a reflection member 40. The lamp cover 10 has a bottom side 12 and a light-emitting side 14 opposing to the bottom side 12, and a reflection layer 16 is disposed at the bottom side 12. The substrate 20 is disposed on the bottom side 12 of the lamp cover 10. The light-emitting unit 30 is disposed on the substrate 20 to emit a plurality of light beams L1 and L2. The reflection member 40 is disposed above the light-emitting unit 30. In the first embodiment of the lamp structure of the invention, the reflection member 40 is disposed on a packaging unit 32 covering the light-emitting unit 30. In other words, the packaging unit 32 and the reflection member 40 are disposed in sequence on the light-emitting unit 30. However, in other embodiments, the reflection member 40 may be disposed above the light-emitting unit 30 through other means, such as through a holder or designing the reflection member 40, and the invention is not limited thereto. In addition, the packaging unit 32 may include a wavelength conversion material, for example, to change a physical property (e.g., wavelength or diffusing properties) of the light beams L1 and L2 after the light beams L1 and L2 pass through the packaging unit 32. Moreover, the light beams L1 and L2 are at least reflected by the reflection layer 16 of the lamp cover 10 to be emitted from the light-emitting side 14 of the lamp cover 10. For example, the forward light beam L1 may be emitted from the light-emitting side 14 of the lamp cover 10 after being reflected by the reflection member 40 and then reflected by the reflection layer 16, while the lateral light beam L2 may be emitted from the light-emitting side 14 of the lamp cover 10 after being directly reflected by the reflection layer 16. In addition, an orthogonal projection of the reflection member 40 on the substrate 10 covers the light-emitting unit 30. Namely, the light-emitting unit 30 is located between the reflection member 40 and the substrate 10. In other words, the reflection member 40 may completely block the forward light of the light-emitting unit 30 to prevent glare. A material of the reflection member 40 may be selected from a group consisting of aluminum, tin, copper, silver, and gold, for example. However, the invention is not limited thereto. In addition, since the material of the reflection member 40 in the lamp structure of the first embodiment of the invention is metal, and metal has a preferable heat dissipating property, the reflection member 40 has a preferable heat dissipating effect. Also, the material of the reflection member 40 is preferably copper. When copper is used as the material of the reflection member 40, the reflection member 40 has a most preferable heat dissipating effect.

In the specification of the invention, the cross-sectional views of the respective embodiments are in a view angle in a lateral direction of the lamp cover 10. Namely, the cross-sectional views are views taken from the light-emitting side 14 to the bottom side 12 of the lamp cover 10. For example, in the lamp structure of the first embodiment of the invention, the cross-sectional view shown in FIG. 1 is taken along a cross-sectional line T-T′ shown in FIG. 2.

Moreover, in the embodiments of the lamp structure of the invention, a minimal distance D1 between the reflection member 40 and the bottom side 12 of the lamp cover 10 may be in a range of 1/2 to 1/3 times of a maximal distance D2 between the light-emitting side 14 and the bottom side 12, for example. By setting the minimal distance D1 of the reflection member 40, the light beams L1 and L2 emitted by the light-emitting unit 30 may be concentrated on the bottom side 12 at a lower half. In addition, the reflection layer 16 may also be disposed on the bottom side 12 at the lower half extending away from the substrate 20. Thus, when the reflection member 40 is located at the position, the light beams L1 and L2 emitted by the light-emitting unit 30 may be concentrated on the bottom side 12 at the lower half, and may be intensively emitted from the light-emitting side 14 of the lamp cover 10 after being reflected by the reflection member 40 and/or the reflection layer 16, so that the light beams L1 and L2 may be concentrated. The configuration is suitable for a lamp requiring concentration of light, such as a projecting lamp. Compared with the conventional art where the reflection layer is disposed on a complete surface in the lamp cover, the reflection layer 16 in the lamp structure of the invention only needs to be disposed on the bottom side 12 at the lower half. Thus, a manufacturing cost is reduced.

In the following, several embodiments of the lamp structure of the invention are described. It should be noted that the embodiments of the lamp structure are described herein for an illustrative purpose and do not serve to limit the invention. The user may combine the technical contents of the respective embodiments based on the practical needs.

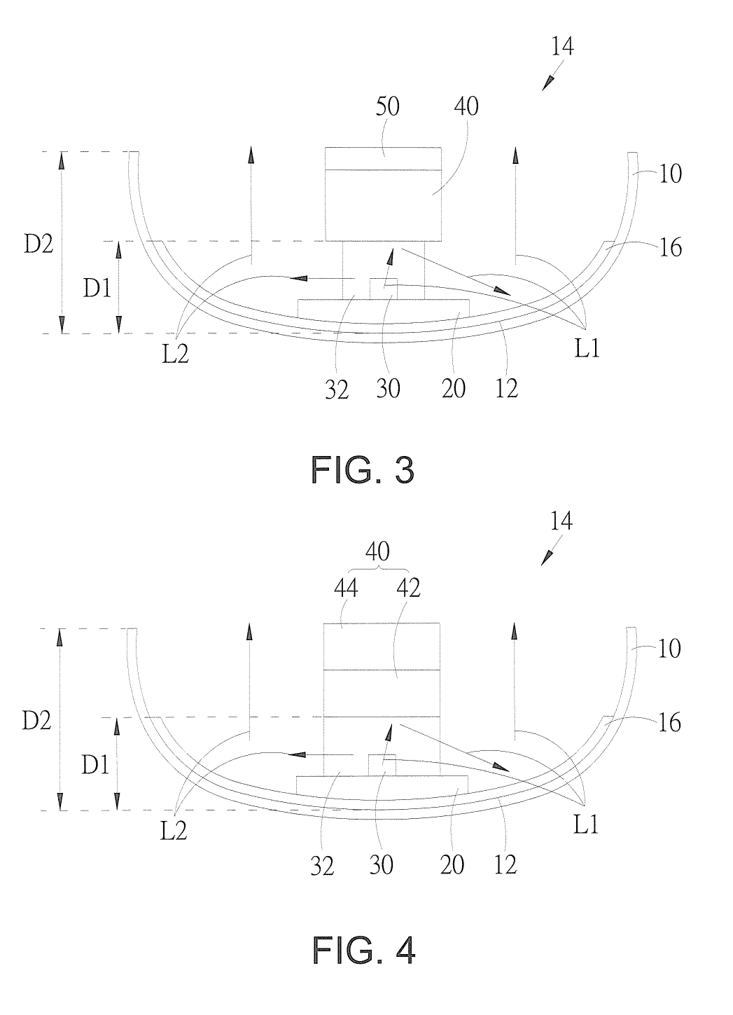

FIG. 3 is a schematic cross-sectional view illustrating a lamp structure according to a second embodiment of the invention. As shown in FIG. 3, a difference of the second embodiment from the first embodiment is that, in the second embodiment of the invention, the reflection member 40 includes a heat dissipating member 50 disposed at a side facing the light-emitting side 14 of the lamp cover 10. Here, the heat dissipating member 50 may be a heat dissipating fin, a heat dissipating tube, or a heat dissipating block, for example. Any component having a heat dissipating function falls within the scope claimed in the invention.

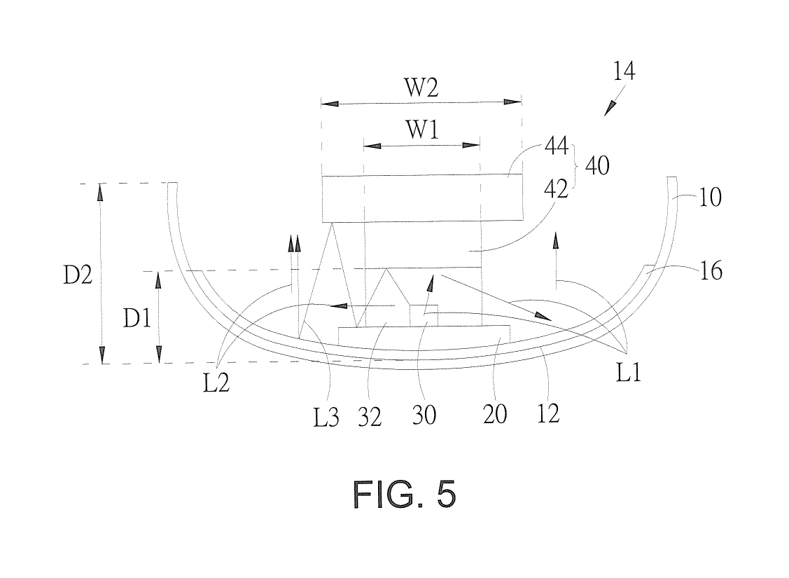

FIG. 4 is a schematic cross-sectional view illustrating a lamp structure according to a third embodiment of the invention, and FIG. 5 is a schematic cross-sectional view illustrating a lamp structure according to a fourth embodiment of the invention. As shown in FIG. 4, a difference of the third embodiment from the first embodiment is that, in the third embodiment of the invention, the reflection member 40 is formed of a first reflection portion 42 and a second reflection portion 44 disposed with respect to the light-emitting unit 30 in sequence. Also, as shown in FIG. 5, in the fourth embodiment of the invention, a width W2 of the second reflection portion 44 may be greater than a width W1 of the first reflection portion 42, so as to cope with the requirements of different light types. For example, in addition to the reflection member 40 and the reflection layer 16 in the lamp structure of the invention configured to reflect the forward light beam L1 and the lateral light beam L2, as the width W2 of the second reflection portion 44 is greater than the width W1 of the first reflection portion 42, a light beam L3 may be emitted from the light-emitting side 14 of the lamp cover 10 after being sequentially reflected by the first reflection portion 42 and the substrate 20 and then reflected by the second reflection portion 44 back to the reflection layer 16. The light beams L1, L2, and L3 are described herein merely for an illustrative purpose, and do not serve to limit the invention. Moreover, in the third and fourth embodiments, the first reflection portion 42 and the second reflection portions 44 may be integrally formed, for example.

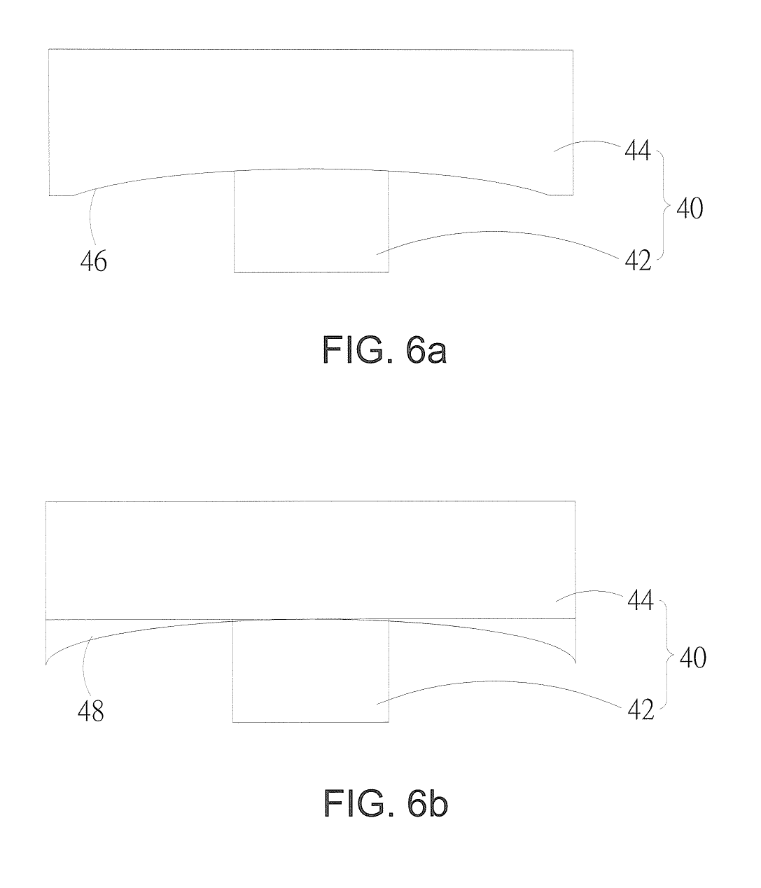

Furthermore, as shown in FIGS. 6a and 6b, in the embodiments of the lamp structure of the invention, a side of the second reflection portion 44 facing the substrate 20 may have a recessed portion 46 or a protruding portion 48, so as to preferably reflect the light beams L1, L2, and L3 emitted by the light-emitting unit 30.

In the following, embodiments with a plural number of the light-emitting units 30 in the lamp structure of the invention are described.

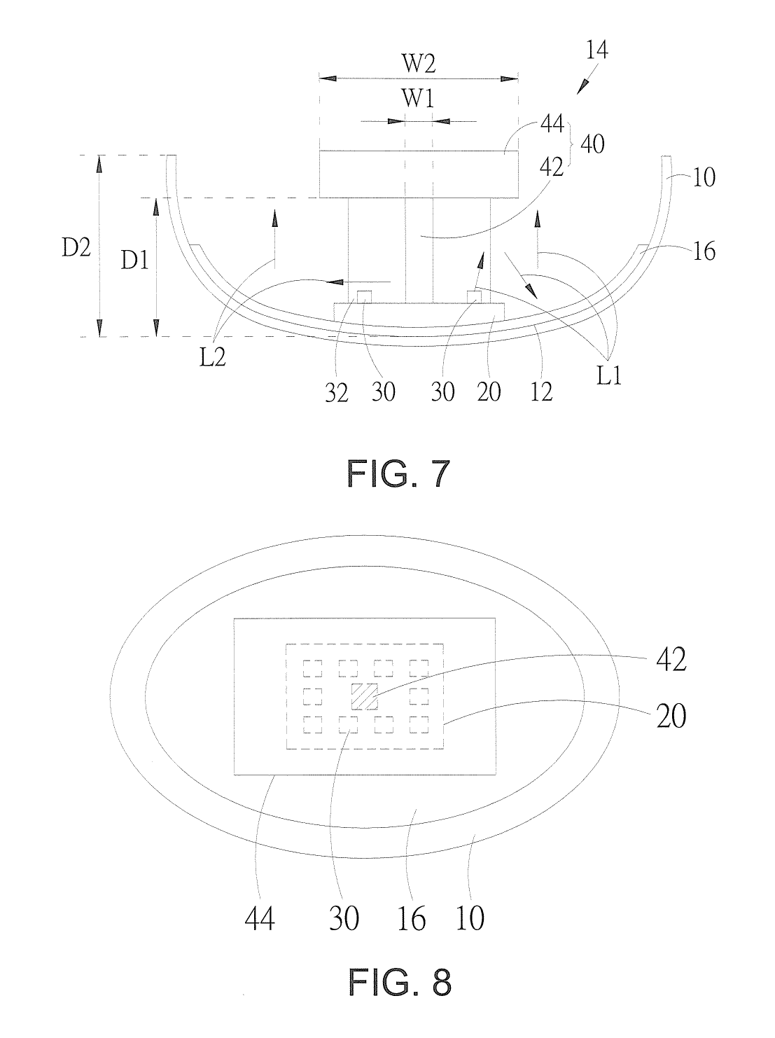

FIG. 7 is a schematic cross-sectional view illustrating a lamp structure according to a fifth embodiment of the invention, and FIG. 8 is a top view of the lamp structure according to the fifth embodiment of the invention shown in FIG. 7. Referring to in FIGS. 7 and 8, a difference of the fifth embodiment from the fourth embodiment is that, in the fifth embodiment of the invention, the number of the light-emitting unit 30 is plural, and the light-emitting units 30 are arranged on the substrate 20. For example, the light emitting units 30 can be arranged on the substrate 20 in a ring. Furthermore, the lamp structure of the invention further includes a packaging unit 32 covering the light-emitting units 30, and the reflection member 42 is surrounded by the packaging unit 32. In addition, as described in the third and fourth embodiments of the lamp structure of the invention, the reflection member 40 includes the first reflection portion 42 and the second reflection portion 44 disposed above the light-emitting unit 30 and the first reflection member 42 is located between the second reflection portion 44 and the substrate 20, and the width W2 of the second reflection portion 44 is greater than the width W1 of the first reflection portion 42. Moreover, the first reflection portion 42 may be fixed on the substrate 20 through screwing, engaging, locking, or adhering, such that the reflection member 40 is disposed above the light-emitting unit 30. For example, as shown in FIG. 7, the reflection member 40 fixes the first reflection portion 42 on the substrate 20 by screwing, for example, in the fifth embodiment of the invention. Also, since the light-emitting units 30 are arranged on the substrate 20 in the ring, the reflection member 40 may be disposed at the center among the light-emitting units 30 arranged in the ring, so as to achieve a preferable reflection effect without influencing light emission. Since the reflection member 40 is fixed on the substrate 20 through direct contact and is disposed above the light-emitting units 30, heat generated by the light-emitting units 30 may be directly transmitted to the substrate 20 and discharged to the external environment. In this way, heat dissipation may be improved. Similarly, as described in the third and fourth embodiments of the lamp structure of the invention, a side of the second reflection portion 44 facing the substrate 20 may have the recessed portion 46 or the protruding portion 48 (see FIGS. 6a and 6b), so as to preferably reflect the light beams L1 and L2 emitted by the light-emitting unit 30.

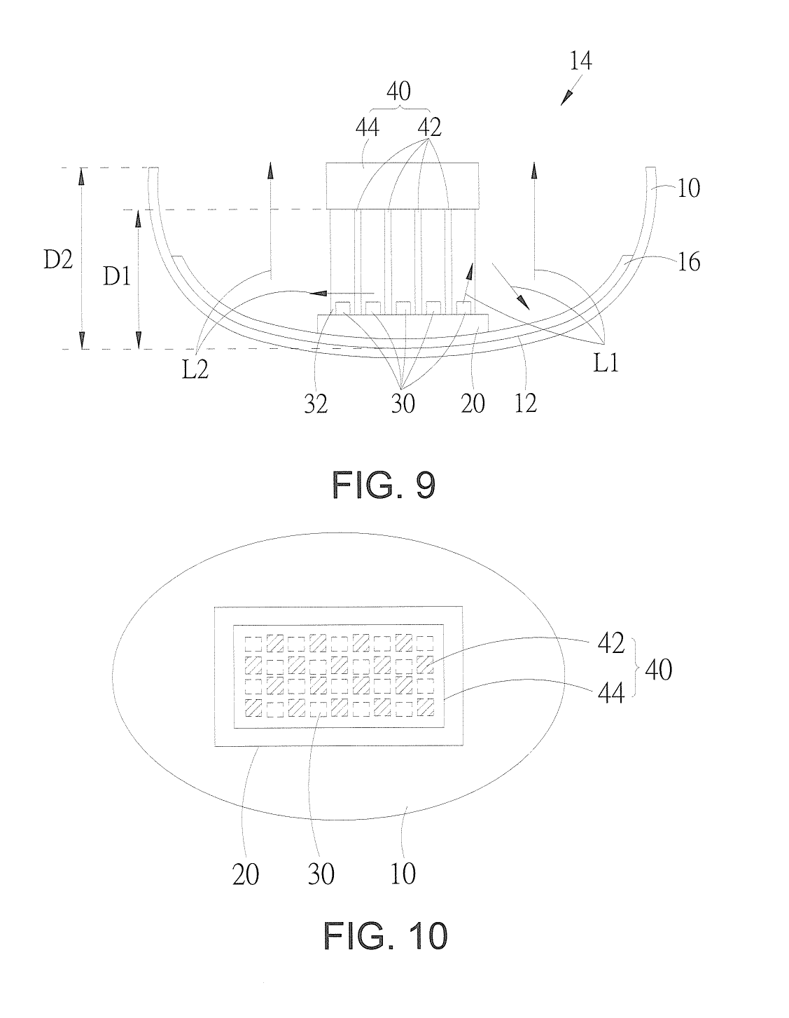

FIG. 9 is a schematic cross-sectional view illustrating a lamp structure according to a sixth embodiment of the invention, and FIG. 10 is a top view of the lamp structure according to the sixth embodiment of the invention. Referring to FIGS. 9 and 10, the sixth embodiment differs from the fifth embodiment in that, in the sixth embodiment of the invention, the numbers of the first reflection portion 42 and the light-emitting unit 30 are plural, and the light-emitting units 30 are disposed between the first reflection portions 42. In addition, at the portion of the first reflection portion 42 is surrounded by the light-emitting units 30. Furthermore, the lamp structure of the invention further includes a plurality of packaging units 32 covering the light-emitting units 30, and the at least portion of the reflection member 42 is surrounded by the packaging units 32.

In view of the foregoing, in the lamp structure of the invention, the reflection layer and the reflection member are disposed in the lamp structure. In this way, the light beams emitted by the light-emitting unit are not directly emitted forwardly from the light-emitting unit, but are emitted from the lamp cover through reflection. In this way, the glare in conventional lamps may be reduced. Also, the heat dissipating member having the heat dissipating function may be further disposed on the reflection member in the lamp structure of the invention. Thus, a heat dissipating efficiency and reliability of the lamp structure may also be improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lamp structure, at least comprising:
a lamp cover, wherein the lamp cover has a bottom side and a light-emitting side opposing to the bottom side, and a reflection layer is disposed at the bottom side;
a substrate, disposed on the bottom side of the lamp cover;
at least one light-emitting unit, disposed on the substrate and emitting a plurality of light beams; and
a reflection member, disposed above the light-emitting unit,
wherein the light beams are at least reflected by the reflection layer of the lamp cover and emitted from the light-emitting side of the lamp cover.

2. The lamp structure as claimed in claim 1, wherein the at least one light-emitting unit are located between the reflection member and the substrate.

3. The lamp structure as claimed in claim 1, wherein a material of the reflection member is selected from a group consisting of aluminum, tin, copper, silver, and gold.

4. The lamp structure as claimed in claim 1, wherein the reflection member comprises a heat dissipating member disposed at a side of the reflection member facing the light-emitting side of the lamp cover.

5. The lamp structure as claimed in claim 1, wherein a minimal distance between the reflection member and the bottom side of the lamp cover is in a range of 1/2 to 1/3 times of a maximal distance between the light-emitting side and the bottom side.

6. The lamp structure as claimed in claim 1, further comprising a packaging unit covering the light-emitting unit, wherein the reflection member is disposed on the packaging unit.

7. The lamp structure as claimed in claim 1, wherein the reflection member comprises a first reflection portion and a second reflection portion, the first reflection portion is located between the second reflection portion and the substrate.

8. The lamp structure as claimed in claim 7, wherein the first reflection member and the second reflection member are integrally formed.

9. The lamp structure as claimed in claim 7, wherein a width of the second reflection portion is greater than a width of the first reflection portion.

10. The lamp structure as claimed in claim 9, wherein a side of the second reflection portion facing the substrate has a recessed portion or a protruding portion.

11. The lamp structure as claimed in claim 10, wherein the first reflection portion is located on the recessed portion or the protruding portion of the second reflection portion.

12. The lamp structure as claimed in claim 7, wherein the number of the light emitting unit is plural and the light-emitting units are arranged on the substrate.

13. The lamp structure as claimed in claim 12, wherein the light-emitting units surround the first reflection portion.

14. The lamp structure as claimed in claim 13, further comprising a packaging unit covering the light-emitting unit, wherein the reflection member is surrounded by the packaging unit.

15. The lamp structure as claimed in claim 12, wherein the first reflection portion is fixed on the substrate through screwing, engaging, locking, or adhering.

16. The lamp structure as claimed in claim 12, wherein a width of the second reflection portion is greater than a width of the first reflection portion.

17. The lamp structure as claimed in claim 15, wherein a side of the second reflection portion facing the substrate has a recessed portion or a protruding portion.

18. The lamp structure as claimed in claim 17, wherein the first reflection portion is located on the recessed portion or the protruding portion of the second reflection portion.

19. The lamp structure as claimed in claim 7, wherein the numbers of the first reflection portion and the light-emitting unit are plural, and each of the light-emitting units is disposed between the corresponding first reflection portions.

20. The lamp structure as claimed in claim 19, wherein at least portion of the first reflection portion is surrounded by the light-emitting units.

21. The lamp structure as claimed in claim 20, further comprising a packaging unit covering the light-emitting units, wherein the at least portion of the reflection member is surrounded by the packaging unit.
